(19) United States
(12) Patent Application Publication
(10) Pub. No.: US 2009/0265149 A1
(43) Pub. Date: Oct. 22, 2009

(54) Method and System for Extracting a Model of Disturbances Induced by Rotating Mechanisms

(76) Inventor: Carl Allen Blaurock, Raleigh, NC (US)

Correspondence Address: Carl Blaurock, 3916 Lauriston Rd, Raleigh, NC, 27616-8612, US

(21) Appl. No.: 12/104,944

(22) Filed: Apr. 17, 2008

(51) Int. Cl. G06F 7/60

(52) U.S. Cl. 703/2

(57) ABSTRACT

The subject invention is a method and system for extracting a model of disturbances induced by rotating mechanisms. Such disturbances can prevent precision structures such as telescopes from meeting their design requirements for dynamic stability. The invention extracts a model of the disturbances from available data, that can be used to predict, identify, and eliminate problematic system performance in the presence of spinning mechanisms.

### FIELD OF THE INVENTION

The present invention relates generally to the field of precision structures, and more particularly to structures which must maintain very precise dynamic stability in the presence of forces induced by on-board spinning mechanisms.

### BACKGROUND

Rotating mechanisms create disturbance forces and moments that can degrade the operation of various precision systems. One particular class of system encompasses optical and other telescopes, which are sensitive to vibration at the micron to nanometer level. This class includes space based observatories. A particular class of mechanism is the Reaction Wheel actuator for spacecraft pointing. This is often the largest source of disturbance forces on the observatory. The characteristic disturbance signature or a rotating mechanism consists of forces and moments at harmonics (integer and non-integer multiples of the wheel speed). Mechanisms also frequently exhibit broadband disturbances with lower forcing magnitudes. Both noise signatures are dynamically amplified by structural modes of the wheel, which are themselves functions of wheel speed through the influence of gyroscopic forces. The dynamic amplification can increase the forcing amplitude by factors of 100 or more. Reaction wheels are particularly problematic because the speed can vary arbitrarily from zero to plus or minus several thousand RPM. Similar forcing characteristics can be found in other spinning mechanisms such as pumps, filter wheels and shutters, and steering mirrors.

An accurate model of the mechanism induced forces, correctly incorporating speed-dependent dynamic amplification, is vital for predicting the resulting mechanism vibration, and thus enabling identification and mitigation of any mission-threatening vibration errors.

The state of the art approach to developing a model of rotating mechanism disturbances is to manually extract a disturbance model from measured disturbance data. Disturbance harmonics are manually identified and manually fit with a fixed speed-dependent amplitude function (most often speed-squared). The vibration data near mechanism resonances is discarded, since the dynamic amplification leads to an erroneously large disturbance prediction.

The subject invention overcomes the limitations of the state of the art in the following ways. The invention allows automatic model extraction, significantly reducing the time required to extract a model while improving the quality of the model. Manually tuned models contain fewer harmonics and ignore the broadband noise signature entirely. Furthermore, the invention simultaneously tunes the mechanism structural dynamic model along with the noise model, providing additional improvement in forcing level predictions. Certain structural characteristics, notably damping, can only be extracted from the mechanism dynamic model.

### SUMMARY OF THE INVENTION

The present invention addresses the need to develop an accurate model of disturbances induced by spinning mechanisms. In a specific exemplary embodiment, mathematical models of the disturbances and the spinning mechanism structure are realized as matrix equations of motion in computer code, and a least squares optimization algorithm is used to automatically tune the model parameters to match measured disturbance data. The model can then be used to predict mechanism disturbances, and resulting degradation in stability, in the operational environment.

### BRIEF DESCRIPTION OF THE DRAWINGS

FIG. 1 is a waterfall plot showing the amplitude of the disturbance force introduced by a spinning mechanism, as a function of rotation speed and temporal frequency.

FIG. 2 is a plot of the integral of the order analysis data, used to identify disturbance harmonics.

FIG. 3 is a diagram of the process for evaluating the cost functional used to tune the mechanism model.

### DETAILED DESCRIPTION OF PREFERRED EMBODIMENT

The invention comprises a system for extracting the parameters that define the forces and moments of a spinning mechanism, using measured force and moment data for a range of rotation speeds. The data consists of time histories of the three forces and three torques referenced to a defined center of measurement, for a range of wheel speeds. These data are acquired as part of the mechanism acceptance testing and thus require no additional resources to obtain.

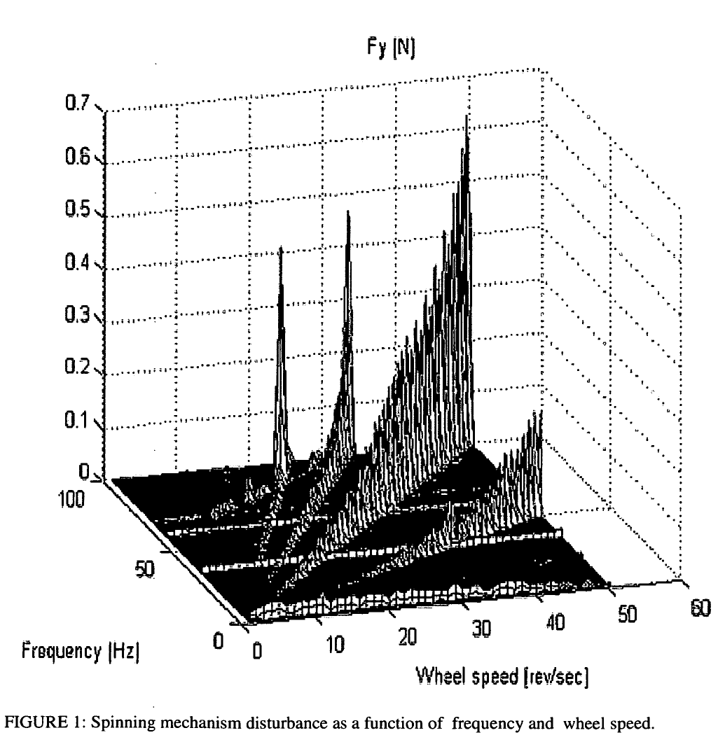

The preferred embodiment is realized as computer code that creates and tunes a mathematical model of forces imparted by the rotating component, filtered by a speed dependent model of the mechanism dynamics. The code implements the following algorithm. The time data is converted to Power Spectral Densities (PSDs) using a Fourier Transform. The PSDs define the forcing amplitudes as a function of temporal frequency and rotation speed. FIG. 1 shows a typical set of disturbance data, called a waterfall plot, showing amplitude versus frequency and spin rate. The mechanism induced disturbances are characterized by a set of six waterfall plots, giving three forces and three torques.

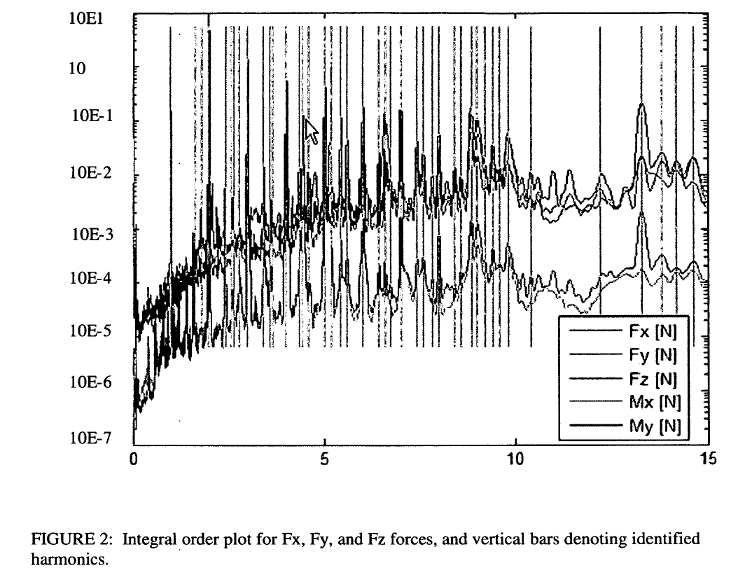

The PSDs are converted to order analysis data by dividing the temporal frequency by the wheel speed, so that the forcing amplitudes are functions of multiples of the wheel speed, or harmonics h. In order analysis form, disturbance harmonics can be identified as constant ridge-lines. Harmonics are automatically identified by collapsing the order analysis data to a scalar function of harmonic factor, then extracting the local maxima. FIG. 2 shows an example of the approach. The plot shows the forcing amplitude versus harmonic, for zero to 15 times the rotation speed. There are five curves representing the Fx, Fy, and Fz forces, and Mx and My torques. The vertical bars indicate the harmonics that are identified in the data. Many techniques can be used to collapse the order data, including but not limited to integration over rotation speed. Those skilled in the art will recognize that various modifications to the approach exist, including but not limited to speed dependent weighting.

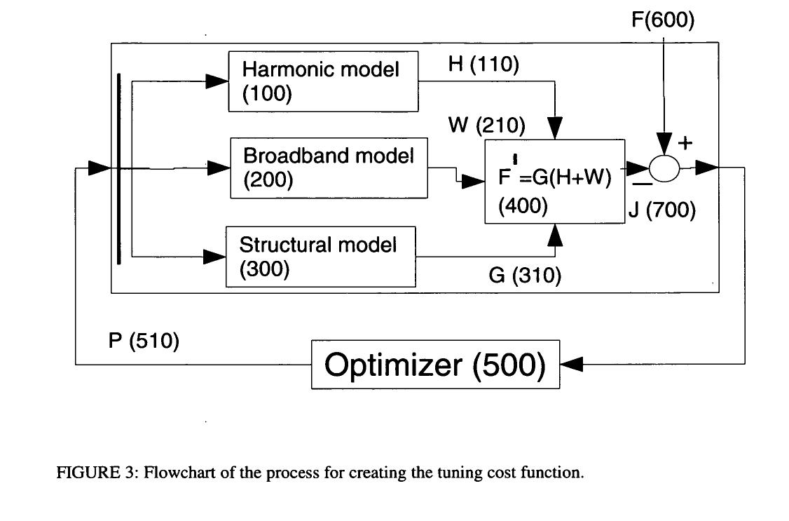

The procedure for tuning the model is diagrammed in FIG. 3. It uses an optimizer (500) to iteratively search for the model parameters that best match the measured data F (600). The parameter vector p (500) is separated into components for the harmonic P_{harmonic}, broadband P_{broadband}, and structural models P_{structure}. Each of the three models is evaluated for each wheel speed and frequency. The harmonic and broadband forces are then summed and filtered by the structural model, and differenced with the measured data to produce the error measure J (700). The parameter vector is then varied by the optimizer in a direction which reduces the error. This sequence is repeated until a predefined maximum error is reached. Any of many commercially available optimizer codes can be used. Those skilled in the art will recognize that gradients of the error cost J can be developed, as a function of the harmonic, broadband, and structural models, and that this will improve the speed and accuracy of the tuning process.

The mathematical models of the forcing behavior of each harmonic, the broadband noise, and the wheel structural dynamics are as follows. The general form for the harmonic forcing model (100) is a speed dependent function g(Ω),

f(t)=g(Ω)sin (hᵢΩt) EQ. 1

where t is time, f (t) is the force or torque time history, Ω is the rotation speed, and hᵢ is the harmonic. A particular example of a speed dependent function is the speed squared model,

f(t)=ċΩ² sin (hᵢΩt) EQ. 2

where c is a harmonic coefficient. Those skilled in the art will recognize that any arbitrary forcing function can be defined in this way. For the broadband noise (200), an arbitrary forcing function can be realized in terms of a speed dependent polynomial,

$$W ( f , Ω ) = C ( Ω ) \frac{N ( f , Ω )}{D ( f , Ω )} \qquad EQ . 3$$

where W(f,Ω) is the disturbance as a function of temporal frequency and speed, C(Ω) is a wheel speed dependent shaping function, and N(f, ) and D(f, Ω) are the speed dependent numerator and denominator polynomials, respectively. Those skilled in the art will recognize that EQ 3 can be equivalently represented in pole/zero/gain form or state space form. The structural dynamics (300) can be written in a general form as

M\ddot{x}+(V+ΩG)\dot{x}+K x=B_{f}f \hat{f}=C_{f}x+D_{f}f EQ. 4

where M is the mass matrix, V is the damping matrix, G is the gyroscopic matrix, K is the stiffness matrix, B_{f} is the force influence matrix, C_{f} is the force observation matrix, D_{f} is the feedthrough matrix, and \hat{f} is the filtered force that is applied to the system. Those skilled in the art will recognize that the structural dynamics matrices can be developed in numerous ways, including but not limited to first-principles modeling and Finite Element modeling. In particular, Finite Element models are always created as part of the design process for spinning mechanisms, and thus are available with no additional effort. Also. those skilled in the art will recognize that the second order Equations of Motion (EOM) in EQ 4 can be equivalently represented in various other forms such as first order EOM.

The models are tuned to the waterfall data using a nonlinear least-squares optimization procedure. The procedure involves defining an error function J that mathematically characterizes the difference between the measured and predicted forces, and that is summed over all the measurement frequencies, rotation speeds, and forcing axes,

$$J = {\sum }_{j = axis} {\sum }_{k = w / s} {\sum }_{l = freq} {( {F}_{jkl} - {\hat{F} ( p )}_{jkl} )}^{2} \qquad EQ . 5$$

The j index runs over the disturbance axes (3 forces and 3 moments), k runs over wheel speeds, and l runs over frequency. p is a variable that represents the variable parameters in the structural, harmonic, and broadband models, denoted P_{structure}, P_{harmonic}, and p_{broadband}, respectively. The predicted force \hat{F}(p) is computed from the harmonic and broadband noise models, and the structural model,

\hat{F}ⱼₖₗ=Ĝⱼₗ(f, Ωₖ, p_{structure})(Wⱼₗ(f, Ωₖ, p_{broadband})+Hⱼₗ(Ωₖpₜₒₙₐₗ)) EQ. 6

The structural model EQ 4 is represented by Ĝⱼₗ which is the frequency response of the model for axis j at frequency l,

Ĝⱼₗ(s, Ωₖ, p_{structure})=C(M s²+V s+GΩₖs+K)⁻¹B EQ. 7

where s is the Laplace variable, s=2πf [symbol] 1. P_{structure} can include any element of the structural response matrices, but would typically include resonance frequencies and damping ratios. Wⱼₗ is the random noise model,

$${W}_{jl} ( f , {Ω}_{k} , {p}_{broadband} ) = C ( Ω ) \frac{N ( f , {Ω}_{k} )}{D ( f , Ω )} \qquad EQ . 8$$

with parameters p_{broadband} that include the coefficients of the speed shaping function C(Ω) and the coefficients of the numerator and denominator polynomials N and D. Hⱼₗ is the harmonic disturbance for axis j at frequency l,

$${H}_{jl} ( {Ω}_{k} , {p}_{harmonic} ) = {\sum }_{m = harmonics} {f}_{m} ( Ω ) sin ( 2 π {h}_{jm} Ω + {Φ}_{jlm} ) \qquad EQ . 9$$

whose parameters p_{harmonic} are the coefficients of the harmonic function fₘ(Ω).

While the above description is of the preferred embodiment of the present invention, it should be appreciated that the invention may be modified, altered, or varied without deviating from the scope and fair meaning of the following claims.

This invention was made with government support under contract NNX08CA33C awarded by NASA. The government has certain rights in this invention.

What is claimed is:

1. a system for extracting a mathematical model of disturbances induced by a spinning mechanism, comprising models of the spin induced disturbances, and the spin rate dependent dynamics of the mechanism,

2. claim of 1, where the spin induced disturbance model consists of a summation of multiple harmonics composed of arbitrary tonal functions of wheel speed, and a broadband noise model that consists of an arbitrary speed and frequency dependent shaping function,

3. claim of 1, where the mechanism structural model consists of an arbitrary matrix Equation of Motion that incorporates a dependence on rotation speed,

4. claim of 1, where the harmonics are automatically identified by collapsing the order analysis data to a scalar function of rotation speed, and then identifying the local maxima

5. claim of 1, where a least squares optimization routine is used to tune the models to the data

6. claim of 1, where the gradients of the noise and structural models can be used to improve tuning speed and accuracy
